(19) United States
(12) Patent Application Publication
(10) Pub. No.: US 2011/0074317 A1
(43) Pub. Date: Mar. 31, 2011

(54) Method and Arrangement for Fan Control

(76) Inventors: John Phillip Gibson, Furth (DE); Maamar Bouchareb, Neubiberg (DE)

(21) Appl. No.: 12/993,630

(22) PCT Filed: Oct. 5, 2009
(86) PCT No.: PCT/EP09/07122

§ 371 Date: Nov. 19, 2010

(30) Foreign Application Priority Data
Oct. 14, 2008 (DE) 10 2008 051 199.4

(51) Int. Cl. H02P 5/46

(52) U.S. Cl. 318/68

(57) ABSTRACT

The invention relates to a method for controlling a number of fans (2) of a heat exchanger that can be used in refrigeration, air conditioning, or process technology. The fans (2) form a number of fan groups (5), and each fan group (5) is connected to an electrical energy supply (7) selectively by means of a constant power supply (14) or by means of a variable power supply (15). The fan group (5) is operated at a constant fan speed with the constant power supply (14) and at a variable fan speed with the variable power supply (15). A power parameter (I) indicating an instantaneous total power demand of all fan groups (5) supplied by means of the variable power supply (15) is detected. At least one of the fan groups (5) that is currently being fed by means of the variable power supply (15) is switched to the constant power supply (14) if the power parameter (I) exceeds a limit value (Iₘₐₓ).

### CROSS-REFERENCE TO RELATED APPLICATIONS

This application is based on PCT Patent Application PCT/EP2009/007122 filed on Oct. 5, 2009 which claims priority to German Patent Application Serial No. 10 2008 051 199.4 filed on Oct. 14, 2008, both of which are hereby incorporated by reference and to which priority is claimed.

### STATEMENT REGARDING FEDERALLY SPONSORED RESEARCH OR DEVELOPMENT

Not applicable.

### BRIEF SUMMARY OF THE INVENTION

The invention concerns a method for controlling a number of fans of a heat exchanger that can be used in refrigeration, air conditioning or process technology. Further, the invention concerns an arrangement for implementing such a method.

In refrigeration, air conditioning and process technology, thermal processes are used in a targeted manner in order to produce cooling or heating in a certain section. One example of this is the refrigeration process that is in turn made up of several sub-processes. For the realization of these sub-processes, specific system components are provided. A sub-process consists, for example, therein, to remove heat from a cooling medium or to supply heat to a heating medium. Hereby, heat exchangers are used that comprise fans in their air-guided design, by means of which ambient air is conveyed to a pipe system that contains the refrigeration or heating medium. The capability of such a heat exchanger can be selected by means of the fan speed within certain limits.

For the selection of the fan rotation speed, frequency converters or voltage dividers are used, for example. Thereby, the frequency converter or the voltage divider controls all fans that are provided within the affected heat exchanger. Previously, the frequency converter or the voltage divider was designed for operating conditions at maximum power consumption, i.e. that condition at which all fans are operated at maximum speed. This is connected with a not insignificant expense.

For this reason, the problem of the invention lies therein, to propose a method and an arrangement of the type described at the beginning in such a way, that it can be realized at the lowest possible expense.

For the solution of this problem, a method in accordance with the characteristics of Claim 1 is proposed. Further, the problem is solved by the arrangement as per claim 10. The essential aspect of the method in accordance with the invention and the arrangement in accordance with the invention consists therein, that for the respective fan group, respectively two paths are provided for the connection to the electric power supply, in particular also to the public grid for supplying electric power. On the one hand, there are, within the scope of constant power supply, an immediate or direct connection of the fan group and thus the fans or their motors to the electric power supply. In the case of this constant power supply, only an operation at constant fan sped is provided. On the other hand, the connection to the electric power supply can also be established by means of a variable power supply so that the speed of the fans of this group of fans can be varied. The type of power supply can be specified for each group of fans independent of the other groups of fans.

Further, the instantaneous total power demand of all fan groups that are operated by means of variable power supply is continually determined and analyzed. If the power parameter detected in this way is above a limit value, an automatic switching of one fan group from the variable power supply to the constant power supply takes place. As a result, the power demand from the variable power supply falls. This switching to constant power supply can take place successively until only one of the fan groups is still operated by means of variable power supply or in the extreme case, even all fan groups are directly connected to the electric power supply, i.e. are operated by means of constant power supply.

It is achieved thereby, that the controlling unit of the variable power supply, i.e, for example, the frequency converter or the voltage divider is to be designed only for a reduced and also specifiable power limit or upper voltage limit. The design takes place only for a portion of the total installed fan power. As a result, effort is reduced and primarily also the costs for these units is lowered significantly.

Beyond that, the dual power supply that is provided in accordance with the invention offers advantages during repair and maintenance. Thus, all fans can continue to be operated by means of constant power supply when a defect is present in the variable power supply. For purposes of repair, the system then does not have to be shut down entirely, as an (emergency) operation continues to be possible by means of the constant power supply. Likewise, fans or fan groups can be switched off in the case of a breakdown, or can be shut off individually for maintenance purposes, whereas the other fans or groups of fans can continue to be operated.

Advantageous designs of the method in accordance with the invention and the arrangement in accordance with the invention result from the characteristics of the dependent claims.

It is favorable to operate as many of the groups of fans as possible by means of variable power supply. This ensures on the one hand that the method is executed at a fan power under the specified (power value) limit value, but is still executed at the largest possible fan power.

Moreover, it is favorable when a direction of rotation of all or at least of individual fans is reversed. Such a reverse rotation of the fans, in particular slow reverse rotation of the fans, preferably leads to a reduction of the convection heat in the case of flat heat exchangers. Preferably, a maximum number of rotations of the fans in this reverse direction of rotation is smaller than that in the forward direction of rotation. By means of the reverse rotation, at least to a certain degree, a reversal of the otherwise actually intended effect, in particular the cooling effect, can be achieved. Then, preferably, no heat is removed from the cooling cycle, but it is ensured that the heat remains within the system. In addition, the fan can be cleaned by means of being rotated in reverse.

Advantageously, this reversal of the direction of rotation can also be provided independent of the dual power supply described above by means of the constant power supply and the variable power supply. The mentioned advantages of the reverse rotation also show advantage in a conventional control arrangement with a single power supply. The possibility of reversing directions can also, in particular, be integrated into a known control unit or regulation unit such as, for example a frequency converter or a voltage divider.

### BRIEF DESCRIPTION OF THE DRAWINGS

Additional characteristics and details of the invention result from the following description of examples of embodiments in conjunction with the drawing. Shown are:

FIG. 1: An example of an embodiment of a condenser belonging to an air conditioning system comprising several fans with a control of the fans;

FIG. 2: A block diagram of an additional example of an embodiment for controlling fans by means of a dual power supply for selective direct operation or converter operation of the fans, and

FIG. 3: A diagram of a characteristic curve of a standard current consumption rate of the fans as per FIG. 2, entered above a standard speed of the fans.

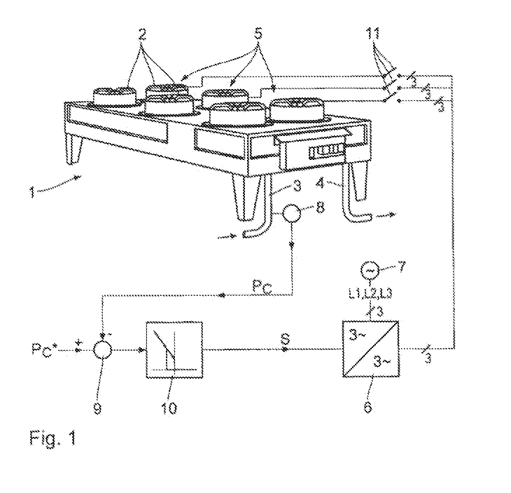

Parts that correspond to each other are provided with the same reference numbers in FIG. 1 to 3.

### DETAILED DESCRIPTION OF PREFERRED EMBODIMENT

In FIG. 1, an example of an embodiment of a condenser 1 is shown with several fans 2. In the example of an embodiment, six fans 2 are provided. The condenser 1 is a component of an air conditioning system that is not shown in further detail. It also includes a—likewise not shown in more detail heat exchanger—by means of which a cooling medium conveyed in a pipe system is transformed from its gaseous phase into the liquid phase. The schematic illustration as per FIG. 1 indicates an inlet pipe 3 and an outlet pipe 4 of this pipe system.

The fans 2 are grouped into a total of three fan groups 5 with respectively 2 fans. The fans 2 of a fan group 5 are respectively controlled jointly.

The control of all fan groups 5 takes place by means of a joint frequency converter 6 that establishes a connection of fans 2 to the electric power grid 7. The grid supply 7 is three-phase. It has three electric phases L1, L2, and L3. But in principle, a different electric power supply, for example, a single-phase supply would also be possible.

The frequency converter 6 converts the grid frequency, the value of which is typically 50 Hz or 60 Hz, into a different frequency, namely the output frequency f, by means of which the fans 5 are controlled and brought to a corresponding number of rotations. The frequency change produced by frequency converter 6 thus causes a change in the number of rotations of the fans in fans 2. As a result, the fan output can be controlled. The air supply generated by fans 2 is to be varied within certain limits.

In order to adapt the selected air supply to the instantaneous demand, a control circuit is provided. First, a measurement variable is detected. For this, inlet pipe 3, by means of which the cooling medium is conveyed to the condenser 1 in the gaseous phase, is provided with a sensor 8 in the form of a measuring transducer for a condensation pressure P_{C}. Alternatively, the condensation pressure P_{C} can also be measured in the drain pipe 4. The sensor 8 is a pressure sensor. It supplies a measurement signal of the condensation pressure P_{C} as instantaneous value of the control to a comparison unit 9, within which a difference between this instantaneous value and a (predeterminable) set point value P_{c} is determined. This actuating variable determined in this way is supplied to a controller 10, which is designed as proportional controller with hysteresis in the example of the embodiment. The controller 10, dependent on the actuating variable on the input side, supplies a control signal S on the output side to the frequency converter 6.

In place of the condensation pressure P_{C}, other measured variables can also be used for the control. Examples of alternatives are a temperature of the liquid cooling medium in the drain pipe 4, a temperature within a secondary cooling cycle that is not shown in further detail, and a temperature that is determined in a different condenser or other heat exchanger. Of course, the control can also be based on several of the mentioned measured variables.

The frequency converter 6 transforms the grid frequency using the control signal S into the output frequency f, by means of which the fans 2 are controlled. If the analysis in controller 10 indicates that a higher fan power is required in order to ensure the desired condensation pressure P_{C}, the control signal S, at the outlet of the frequency converter 6 causes a higher output frequency f for supplying power to the fans 2.

The fan groups 5 can be switched on or off respectively separately and independent of each other by means of switch units 11. The frequency converter 6 supplies all fan groups 5 when switch units 11 are connected. The fan groups 5 are connected parallel to the outlet of frequency converter 6.

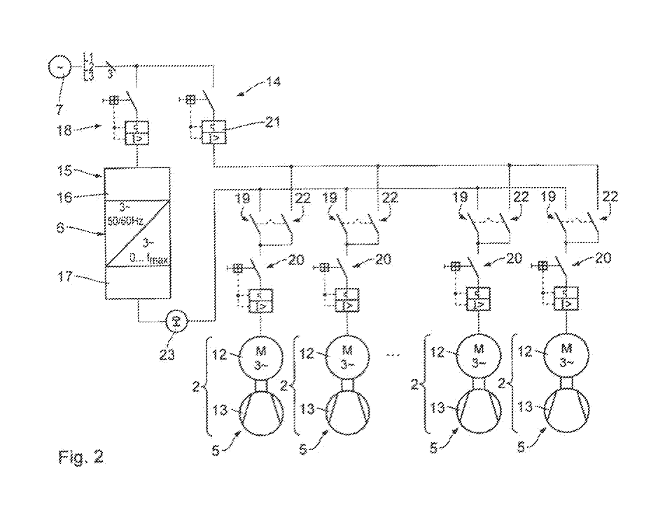

In FIG. 2, an especially favorable design of the control of the fans 2 is shown. The fans 2 respectively comprise an electric driving motor 12, as well as the actual fan wheel 13, that is put into a rotating motion by the driving motor 12. The example of an embodiment shown in FIG. 2 comprises several fan groups 5, with respectively only one single fan 2. However, this is not to be understood as being limiting. In principle, fan groups can also comprise two fans 2 or an even larger number of fans 2. In FIG. 2, for example, and also not limiting, four fan groups 5 are shown.

Each fan group 5 can be connected to the power grid 7 by means of a constant power supply 14 and by means of a variable power supply 15. Via a constant power supply 14, this connection is immediate or direct, via a variable power supply 15, in contrast, indirect. The paths of the constant power supply 14 and the path of the variable power supply 15 are connected in parallel. They can be connected selectively, but in particular, not simultaneously.

The variable power supply 15 is a controlled supply. It includes the frequency converter 6 that is equipped at the input side with an optional EMC filter 16 and at the outlet side with an additional optional motor filter 17, which is also provided for EMC purposes and also serves to protect the driving motors 12. The frequency converter 16 is connected to the grid power supply 7 at the input side by means of a converter power switch 18 that belongs to a variable power supply 15. The converter power switch 18 serves to protect the frequency converter 6. All fan groups 5 are connected in parallel to the outlet of the frequency converter 7. Each connection path to one of the fan groups 5 comprises two additional switch units, namely respectively one convertor contactor 19 that belongs to the variable power supply 15, as well as a fan output switch 20. The power supply via the frequency converter 6 can be switched on or off by means of the converter contactor 19. In each fan power supply path, the fan output protection switch 20 serves to protect the power supply of the respective fan. group 5, as well as a safe and fast electrical break of this fan power supply path. Beyond that, one of the fan groups 5 can be switched off for maintenance.

The second power supply, i.e. the constant power supply 14 comprises a cable power switch 21 for the protection of the electrical cables of the constant power supply 14. Moreover, in the fan power supply path of each fan group 5 it comprises a direct power supply contactor 22 located upstream of the respective fan output switch 20.

The converter contactor 19 and the direct power supply contactor 22 of the fan power supply path of a fan group 5 are mechanically locked, so that the two contactors 19 and 22 of a fan power supply path can never be in their closed (=switched on) condition simultaneously. However, other switching statuses are possible. One of the two contactors 19 and 22 can be closed, whereby, however, the other of the two contactors 19 and 22 is open. The condition shown in FIG. 2 is also possible, in which both contactors 19 and 22 are open. The control and coordination of the switch condition of the mentioned switch units, i.e. the converter power switch 18, the cable power switch 21, as well as the converter contactor 19 and the direct power supply contactor 22 and the fan output switch 20 takes place in particular by means of a joint control unit that is not shown.

In the examples of embodiments shown in FIGS. 1 and 2, in each fan group 5, a respectively equal number of fans 2 is provided. But if required, the fan groups 5 can also comprise a variable number of fans 2. Likewise, the variable power supply 15 can, in place of the frequency converter 6, also comprise another unit, by means of which the number of rotations of the fans 2 can be selected variably. For example, such an alternative design can be a voltage divider, in particular on the basis of a thyristor or a transformer.

A special control process is provided for the discretionary switching on and off of the constant power supply 14 and the variable power supply 15, which is described in more detail in the following. This control process is preferably implemented in the already mentioned control unit that was not illustrated in further detail.

As primary mode of operation, the variable power supply 15 is provided for all fan groups 5. Thereby it is ensured that the number of rotation of all fans 2 in all fan groups 5 can be selected as needed and thus variable by means of the control explained in conjunction with FIG. 1. The frequency converter 6 is designed in such a way that it can cover the power demand of all connected fans 2.

Because of the provided, especially advantageous dual power supply by means of the variable power supply 15 on the one hand and the constant power supply 14 on the other hand it is possible, however, to design the frequency converter 6 for a lower total power than the sum of all maximum outputs of all fans 2, i.e. than the total power installed.

Using a sensor 23, the instantaneous joint power demand of all fan groups 5 that are connected to the variable power supply 15 is continually determined. In the shown example of an embodiment, the sensor 23 is a voltage sensor that is integrated into a joint output line of the frequency converter 6 that supplies all fan groups 5. Alternatively, sensor 23 can also be designed as component of frequency converter 6. The voltage demand for supplying power for variable numbers of rotation of fan groups 5 rises quadratically with the output frequency f of the frequency converter 6 or with the speed of the fans 2.

This means that the frequency converter 6, precisely in the case of high values of the number of rotations, must supply disproportionately high voltage or power. Thereby, the frequency converter 6 would have to be dimensioned correspondingly powerful by itself, which would, however, be associated with significant (cost) effort. In order to minimize this effort, the actual output current I on the output side of the frequency converter 6 that is supplied to all connected fan groups 5, is detected as power parameter and analyzed. In this analysis it is continually reviewed if the actual output current I exceeds a limit value Iₘₐₓ. If this is the case, one of the fan groups 5 is switched during the running operation from the variable power supply 15 to the constant power supply 14. This takes place as a result of an opening of the converter contactor 19 and a closing of the direct power supply contactor 22 in the fan power supply path of the affected fan group 5. As a result, this fan group 5 is operated directly at the electric grid supply 7. A change in the number of rotations of this group of fans 5 is then no longer possible. The number of rotations is determined by the grid frequency (50 Hz, 60 Hz). As a result of this step, however, the frequency converter 6 is relieved of load at the same time. Its load of current falls suddenly by that share that was up to that time required for supplying the fan group 5, which is now operated by being supplied directly by the electric power grid 7.

The monitoring of the power parameter, i.e. the output current I, continues even after this type of switching of the power supply for a first fan group 5. If the actual value of the output current I once again approaches the limit value Iₘₐₓ, an additional fan group 5 is switched in the same way as the first fan group 5, from the variable power supply 15 to the constant power supply 14. This happens successively until only the last fan group 5 is still operated by means of the variable power supply 15. All other fan groups 5 are then connected directly to the electric power grid 7.

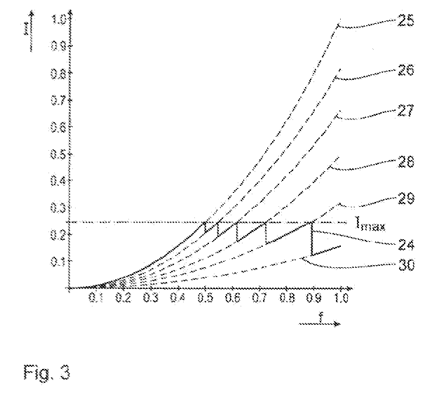

FIG. 3 shows a diagram in which the standard output current I of the frequency converter 6 is entered above the standard output frequency f of converter 6. By way of example, a total of six fan groups 5 are provided here. At low frequency values (≦0.5) all six fan groups 5 are connected to the frequency converter 6. The entire arrangement is operated by means of the variable power supply 15. In this example of an embodiment, the output current I reaches the limit value lₘₐₓ for the first time at an output frequency f of 0.05, so that the first fan group 5 is switched to the constant power supply 14. As a result, the current load/power load of the frequency converter 6 is reduced suddenly. In the case of further increasing output frequency f, the value of the output current I again comes close to the limit value Iₘₐₓ, whereupon the second fan group 5 is switched over to the constant power supply. This continues—as mentioned already—until only the sixth fan group 5 is operated at the frequency converter 6.

This control of the fan groups 5 has the decisive advantage that for the frequency converter 6 that is required for a change in the number of rotations of the fans 2 does not need to be designed for the maximum installed output of all fans 2. Instead, an upper limit for the output requirement of the power requirement for which the frequency converter 6 is to be designed can be specified by means of the limit value Iₘₐₓ of the power parameter I. In the example of an embodiment shown in FIG. 3, the limit value Iₘₐₓ is a fourth of the current value that corresponds to the total installed fan output. In principle, this limit value Iₘₐₓ can also be set to different values.

In FIG. 3, the current demand is symbolized by the solid line 24 in dependence on the standard output frequency f. For comparison, in the diagram as per FIG. 3, dotted lines are also shown 25, 26, 27, 28, 29 and 30, that show the current load of the frequency converter 6 or the current consumption of the fan groups 5 at six, five, four, three, two or one fan(s) 2 that are connected to the frequency converter 6. The reduction of the current load at higher output frequencies f is obvious.

Preferably, so many fan groups 5 or fans 2. are operated by means of the variable power supply 15 so that the output current I of the frequency converter 6 does not exceed [stays just under] the limit value Iₘₐₓ. Thereby it is ensured that for one, the current load of the frequency converter 6 remains limited and for another, the fan output of fans 2 is selected according to the instantaneously detected demand in spite of that.

Moreover, a further mode of operation is possible. It ensures an emergency operation in the event, within a variable power supply 15, in particular in frequency converter 6, a defect occurs. Then, all fan groups 5 are switched to constant power supply 14 and operated directly with grid power supply 7. The variable power supply 15 can then be repaired, without having to shut down the system entirely. In principle, this emergency operation can also be selected for only one or for several, but not for all fan groups 5.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. Method for controlling a number of fans (2) of a heat exchanger that can be used in refrigeration, air conditioning or process technology, whereby
a. the fans (2) form several fan groups (5) and each fan group (5) is selectively connected to an electric power supply (7) by means of a constant power supply (14) or by means of a variable power supply (15);
b. the fan group (5) is operated at constant power supply (14) with a constant number of fan rotations and at a variable power supply (15), it is operated with a variable fan speed;
c. a power parameter (I), that indicates an instantaneous total power demand of all fan groups (5) that are supplied by means of variable power supply (15) is detected;
d. at least one of the fan groups (5) that is currently being supplied by variable power supply (15) is switched to constant power supply (14), when the power parameter (I) exceeds a limit value (Iₘₐₓ).

2. Method according to claim 1, characterized by, that the fan groups (5) are formed respectively by a fan (2) or by several fans (2).

3. Method according to claim 1, characterized by, that all fan groups (5) are respectively equipped with the same number of fans (2).

4. Method according to claim 1, characterized by, that for variable power supply (15), a frequency conversion or a voltage division is provided.

5. Method according to claim 1, characterized by, that during normal operating conditions, as many fan groups (5) as possible are operated by means of the variable power supply (15), without exceeding the limit value (Iₘₐₓ).

6. Method according to claim 1, characterized by, that during normal operating conditions, at least one of the fan groups (5) is operated by means of the variable power supply (15).

7. according to claim 1, characterized by, that at least one fan group (5), in particular all fan groups (5) are operated by means of the direct power supply (14) during an emergency operation.

8. Method according, to claim 1, characterized by, that a direction of rotation of the fans (2) can be reversed.

9. Method according to claim 8, characterized by, that a maximum number of rotations of the fans (2) is smaller in the reverse direction of rotation than in the forward direction of rotation.

10. Arrangement for executing a method according to one of the preceding claims.
